(19) United States
(12) Patent Application Publication
(10) Pub. No.: US 2026/0076868 A1
(43) Pub. Date: Mar. 19, 2026

(54) Portable miniature massage gun

(71) Applicant: Shenzhen Jianchao Intelligent Technology Co., Ltd, Shenzhen (CN)

(72) Inventors: Qunhua Wang, Shenzhen (CN); Fude Li, Shenzhen (CN)

(21) Appl. No.: 19/402,653

(22) Filed: Nov. 26, 2025

(30) Foreign Application Priority Data
May 6, 2025 (CN) 202510575054.9

(51) Int. Cl. A61H 23/02

(52) U.S. Cl. CPC A61H 23/0263; A61H 2201/0153; A61H 2201/0157; A61H 2201/0165; A61H 2201/1418; A61H 2201/149; A61H 2201/1664; A61H 2201/5025

(57) ABSTRACT

A portable miniature massage gun is provided, and belongs to the technical field of massage guns. The portable miniature massage gun includes: a housing, in which a hollow cavity is provided; a motor, mounted inside the housing, where a rotating shaft of the motor is connected with an eccentric wheel; a transmission mechanism, slidably mounted inside the housing, where the transmission mechanism is configured to be driven by the eccentric wheel and drive a massage head to do reciprocating motion; and a power source, configured to supply electrical energy. A corner is formed between the motor and the transmission mechanism. The power source is mounted at the corner inside the housing to make the housing flat. High integration and ultra-miniaturization of a massage gun product are implemented, and portability, maneuverability, and usage comfort are significantly improved.

### TECHNICAL FIELD

The present disclosure belongs to the technical field of massage guns, and relates to a portable miniature massage gun.

### BACKGROUND

As a muscle massage device, a massage gun can effectively assist in muscle relaxation after a user does high-intensity exercises. The massage gun is highly favored by fitness enthusiasts and outdoor sports enthusiasts.

The massage gun mainly uses the crank sliding principle to drive a massage head to perform reciprocating motion through cooperation between a motor and a transmission mechanism. Due to technical reasons and limitations of a working principle, among structures inside the massage gun, a motor needs to be perpendicular to a transmission mechanism, so as to, on the one hand, facilitate a user to hold a desired handle, and on the other hand, increase the utilization rate of an internal space of the handle and prolong the battery life of the massage gun. Therefore, the massage guns in the existing art are all of corner structures.

With the development of the massage gun, the fitness enthusiasts are unwilling to use a public massage gun in a gym due to hygiene reasons, and the outdoor enthusiasts also hope to reduce the weight of the massage gun for easy carrying. Portable mini massage guns have become popular on the market. These massage guns are made to be ⅓ of the size of an ordinary massage gun or even smaller by reducing the size of a battery and the size of the transmission mechanism.

However, the layout of the traditional massage gun has formed a technological inertia. The mini massage gun has a relatively small volume itself. In this case, a handle reserved in the corner layout is much smaller than the size of a palm. This layout is not convenient for gripping and also causes a space waste.

### SUMMARY

For the shortcomings in the existing art, the present disclosure aims to provide a portable miniature massage gun, so as to solve the problem that it is inconvenient to carry the massage gun due to a large overall volume of the massage gun because the existing massage gun has a complicated internal structure and has a high requirement for a housing space.

In order to achieve the above objective, the present disclosure adopts the following technical solutions:

A portable miniature massage gun includes:
a housing, where a hollow cavity is provided in the housing;
a motor, mounted inside the housing, where a rotating shaft of the motor is connected with an eccentric wheel;
a transmission mechanism, slidably mounted inside the housing, where the transmission mechanism is configured to be driven by the eccentric wheel and drive a massage head to do reciprocating motion; and
a power source, configured to supply electrical energy,
where a corner is formed between the motor and the transmission mechanism; and the power source is mounted at the corner inside the housing to make the housing flat.

Further, an eccentric circular boss is arranged on the eccentric wheel; a central axis of the eccentric circular boss is staggered from an output shaft of the motor; and
in an axial projection direction, the output shaft of the motor is located within a contour of an outer edge of the eccentric circular boss, to cause the output shaft of the motor to extend into the eccentric circular boss.

Further, a circular slot is formed in one end of the transmission rod; the end of the transmission rod sleeves an outer side of the eccentric circular boss through the circular slot; and a bearing is arranged between the eccentric circular boss and the transmission rod.

Further, the motor is an outer rotor motor. The motor is mounted inside the housing through a fixed plate.

A maximum radius of an outer wall of the circular slot is r; an eccentric distance of the eccentric circular boss is d; and a radius of the fixed plate is R.

A sum of the maximum radius r of the outer wall of the circular slot and the eccentric distance d of the eccentric circular boss is less than the radius R of the fixed plate, to cause an outer diameter of a circumferential displacement trajectory of the transmission rod to be less than an outer diameter of the fixed plate.

Further, a first shock-absorbing pad is arranged on an outer side wall of the fixed plate; and the first shock-absorbing pad is located between the fixed plate and the housing.

Further, the transmission mechanism includes a transmission rod and a sleeve. Two ends of the transmission rod are respectively hinged with the sleeve and the eccentric wheel. A hinged joint between the transmission rod and the sleeve is located inside the sleeve.

Further, a positioning hole is formed in a side wall of the sleeve. A through hole is formed in the transmission rod. An insertion pin is arranged in the positioning hole and the through hole to implement hinging between the transmission rod and the sleeve.

Further, a bushing is arranged between the transmission rod and the sleeve. The bushing is in close contact with an inner wall of the sleeve.

The bushing extends into the through hole and is located between an inner wall of the through hole and the insertion pin.

Further, a sliding shaft sleeve is arranged inside the housing. The sleeve is located inside the sliding shaft sleeve. A silicone sleeve is arranged between the sliding shaft sleeve and the housing.

Further, the miniature massage gun further includes a control panel. The control panel is located above the transmission mechanism, and the control panel is provided with an operation button and a power indicator lamp.

By applying the technical solutions of the present disclosure, the power source is transversely arranged at the corner between the motor and the transmission mechanism, thus effectively utilizing a space that is originally complex in structure and is hardly used. This increases the overall utilization rate of an internal space of he housing and meets a miniaturization requirement of portable equipment. The horizontal layout breaks through the technical inertia of the traditional corner structure, avoids a redundant handle design, and makes a more compact overall shape. It is conductive to creating a mini, lightweight massage gun which is suitable for outdoor carrying and carrying around. By eliminating the traditional handle structure design, the problem that a miniature massage gun has a very short handle which is not convenient for holding is solved, and it is easier to grab and operate the entire machine, thus enhancing a user experience.

Other features and advantages of the present disclosure will be elaborated in subsequent specification, and will be partially apparent from the specification or understood through the implementation of the present disclosure. The objectives and other advantages of the present disclosure can be achieved and obtained through the structures particularly pointed out in this specification and accompanying drawings.

### BRIEF DESCRIPTION OF THE DRAWINGS

The following will make a detailed description to the present disclosure in conjunction with the present disclosure, making the above advantages of the present disclosure clearer.

FIG. 1 is a schematic diagram of a portable miniature massage gun according to the present disclosure;

FIG. 2 is a schematic diagram of a layout of a portable miniature massage gun according to the present disclosure;

FIG. 3 is a schematic diagram of an inside of a portable miniature massage gun according to the present disclosure;

FIG. 4 is a cross-sectional view of a portable miniature massage gun according to the present disclosure;

FIG. 5 is a partially schematic diagram of a portable miniature massage gun according to the present disclosure;

FIG. 6 is a schematic diagram of a motor of a portable miniature massage gun according to the present disclosure;

FIG. 7 is a schematic diagram of a motor mounting size of a portable miniature massage gun according to the present disclosure;

FIG. 8 is a schematic diagram of a transmission structure of a portable miniature massage gun according to the present disclosure; and

FIG. 9 is a cross-sectional view of a transmission structure of a portable miniature massage gun according to the present disclosure.

### DETAILED DESCRIPTION OF THE EMBODIMENTS

Detail description of the embodiments of present disclosure will be made in the following, and examples thereof are illustrated in the drawings, throughout which identical or similar elements or elements of identical or similar functions are represented with identical or similar reference numerals. The embodiments that are described with reference to the accompanying drawings are exemplary, and are only used to interpret the present disclosure, instead limiting the present disclosure.

In the descriptions of the present disclosure, it should be understood that orientations or positional relationships indicated by the terms “length”, “width”, “upper”, “lower”, “front”, “rear”, “left”, “right”, “vertical”, “horizontal”, “top”, “bottom”, “inner”, “outer”, and the like are orientations or positional relationships as shown in the drawings, and are only for the purpose of facilitating and simplifying the descriptions of the present disclosure instead of indicating or implying that devices or elements indicated must have particular orientations, and be constructed and operated in the particular orientations, so that these terms are not construed as limiting the present disclosure.

In addition, the terms “first” and “second” are used for descriptive purposes only and are not to be construed as indicating or implying relative importance or to implicitly indicate the number of technical features indicated. From this, features defined as “first” and second” may explicitly or implicitly include one or more features. In the description of the present invention, “plurality” means two or more, unless otherwise expressly and specifically defined.

In the embodiments of the present disclosure, unless otherwise expressly specified and limited, the terms “mount”, “connect”, “connection”, “fix”, and the like should be understood in a broad sense, such as, a fixed connection, a detachable connection, an integrated connection, a mechanical connection, an electrical connection, a direct connection, an indirect connection through an intermediate medium, an internal communication of two elements, or interaction between two elements. For those of ordinary skill in the art, the specific meanings of the aforementioned terms in the present disclosure can be understood based on specific conditions.

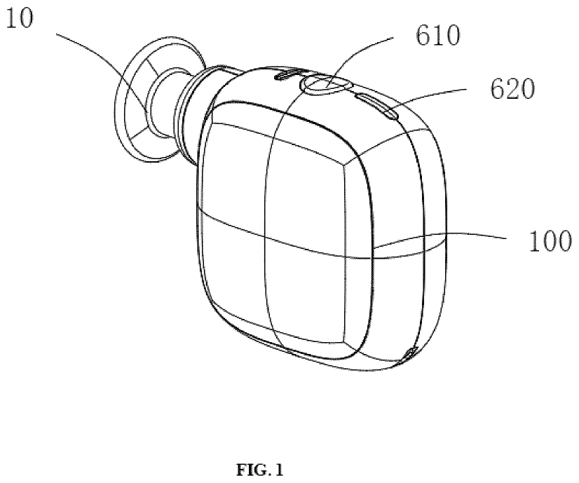

Referring to FIG. 1 to FIG. 3, a portable miniature massage gun includes:
a housing 100, where a hollow cavity is provided in the housing 100;
a motor 200, mounted inside the housing 100, where a rotating shaft of the motor 200 is connected with an eccentric wheel 300;
a transmission mechanism 400, slidably mounted inside the housing 100, where the transmission mechanism 400 is configured to be driven by the eccentric wheel 300 and drive a massage head 10 to do reciprocating motion; and
a power source 500, configured to supply electrical energy,
where a corner is formed between the motor 200 and the transmission mechanism 400. The power source 500 is mounted at the corner inside the housing 100 to make the housing 100 flat. A difference from the existing art is that the present disclosure designs a corner structure with an angle between the motor 200 and the transmission mechanism 400 by optimizing the overall structural layout, and arranges the power source 500 at this corner. This horizontal arrangement breaks through the inertia of the design in which the traditional massage gun has a vertical handle and a longitudinal battery. While ensuring the complete functionality of internal elements, it significantly increases the utilization rate of the internal space of the housing 100 and effectively reduces the length of the whole machine. This is conductive to developing the appearance of the whole machine towards a flat short axis, making it more suitable for carrying around.

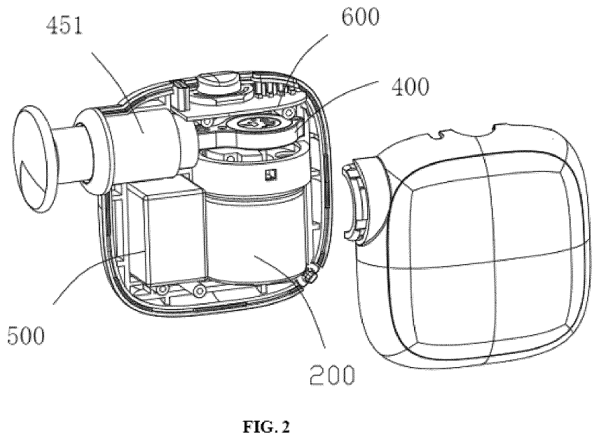

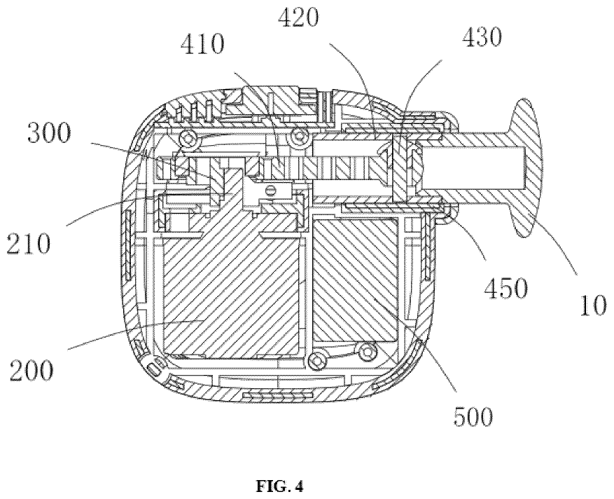

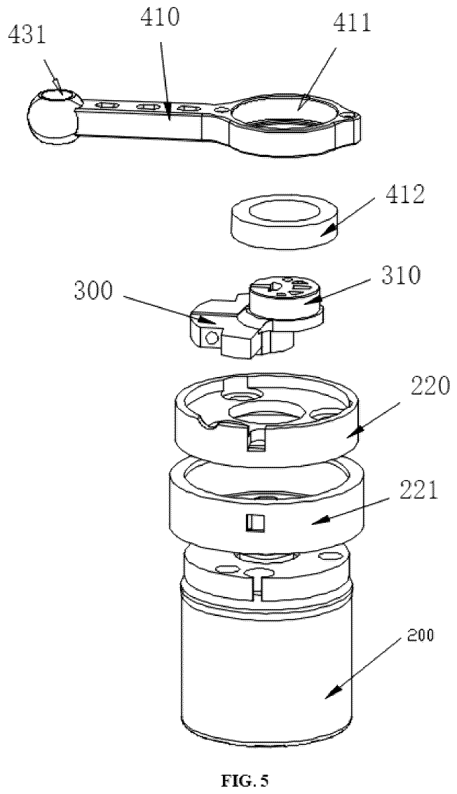

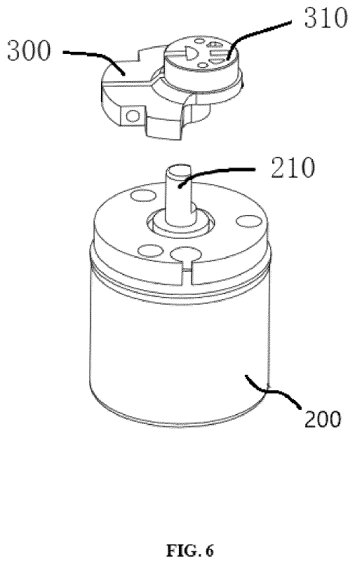

Referring to FIG. 2 to FIG. 6, in this implementation case, an eccentric circular boss 310 is arranged on the eccentric wheel 300. A central axis of the eccentric circular boss 310 is staggered from an output shaft 210 of the motor 200.

In an axial projection direction, the output shaft 210 of the motor 200 is located within a contour of an outer edge of the eccentric circular boss 310, to cause the output shaft 210 of the motor 200 to extend into the eccentric circular boss 310. The traditional massage gun adopts the eccentric wheel 300, which requires the bearing 412 to be arranged above the rotating shaft of the motor 200 and occupies a large longitudinal space. While ensuring the integrity of the eccentric transmission function, this structural design maximizes, through longitudinal stacking of the output shaft 210 of the motor 200 and the eccentric wheel 300, the reduction of a space occupied by the output shaft and the eccentric wheel in an axial direction. High integration is implemented in an insertion-type stacking manner. This further reduces the size of the entire massage gun, which helps to implement an ultra-small design of a product and satisfy a trend of portability.

In this implementation case, a circular slot 411 is formed in one end of the transmission rod 410. The end of the transmission rod 410 sleeves an outer side of the eccentric circular boss 310 through the circular slot 411. A bearing 412 is arranged between the eccentric circular boss 310 and the transmission rod 410. This solution provides a sufficient space in a horizontal direction by mounting the eccentric circular boss 310 on the output shaft 210 of the motor 200 and staggering the central axis of the eccentric circular boss 310 from the rotating shaft of the motor 200, thereby avoiding direct interference between the bearing 412 and the rotating shaft of the motor 200, and reducing an overall height size of the massage gun.

In this solution, the circular slot 411 is formed in one end of the transmission rod 410, and the end of the transmission rod 410 sleeves the outer side of the eccentric circular boss 310 through the bearing 412, so that the position of the bearing 412 is optimized and is not higher than the rotating shaft of the motor 200, thus reducing the overall height. The space utilization is maximized. In the axial projection direction, the output shaft 210 of the motor 200 is located inside the contour of the eccentric circular boss 310, which means that the rotating shaft of the motor 200 can be partially embedded into the eccentric circular boss 310. This reduces the height occupation of the bearing 412 relative to the rotating shaft of the motor 200, making the overall structure more compact.

In this implementation case, the motor 200 is an outer rotor motor. The motor 200 is mounted inside the housing 100 through a fixed plate 220.

A maximum radius of an outer wall of the circular slot 411 is r. An eccentric distance of the eccentric circular boss 310 is d. A radius of the fixed plate 220 is R.

A sum of the maximum radius r of the outer wall of the circular slot 411 and the eccentric distance d of the eccentric circular boss 310 is less than the radius R of the fixed plate 220, to cause an outer diameter of a circumferential displacement trajectory of the transmission rod 410 to be less than an outer diameter of the fixed plate 220.

By making the sum of the maximum radius of the outer wall of the circular slot 411 and the eccentric distance less than the radius of the fixed plate 220, it is ensured that a motion trajectory of the transmission rod 410 cannot exceed the contour of the outer wall of the fixed plate 220, so that the massage gun is smaller in size. The eccentric circular boss 310 is mounted on the output shaft 210 of the motor 200. Since the central axis of the eccentric circular boss is staggered from the rotating shaft of the motor 200, and the transmission rod 410 sleeves the outer side of the eccentric circular boss 310 through the circular slot 411 and transmits motion through the bearing 412, thus causing the end of the transmission rod 410 to do reciprocating motion in the horizontal direction and ultimately driving the massage head 10 for impact massage, with a parameter constraint r+d<R. This means that a maximum motion range, i.e. the outer diameter, of the transmission rod 410 is always smaller than the radius of the fixed plate 220, to ensure proper motion of the transmission rod inside the structure and not exceeding the outer diameter of the fixed plate 220. This design makes the overall structure more compact, avoids excessive space occupation, and makes the entire equipment smaller and more portable.

In this implementation case, a first shock-absorbing pad 221 is arranged on an outer side wall of the fixed plate 220. The first shock-absorbing pad 221 is located between the fixed plate 220 and the housing 100. A stator of the motor 200 is connected to the fixed plate 220, and a positioning slot 110 is formed inside the housing 100. The fixed plate 220 is located inside the positioning slot 110. A difference from a common method in the existing art in which the motor 200 is fixed to the housing 100 through cooperation between a metal bracket and a screw is that this technical solution eliminates a traditional screw mounting structure. By designing the positioning slot 110 inside the housing 100, the fixed plate 220 can be directly inserted and positioned and implement snap-in connection or compression fit. This method not only simplifies an assembling process and reduces manufacturing and maintenance costs, but also effectively reduces structural layers and a mounting thickness. This is conducive to a flat design of the entire machine.

In addition, the positioning slot 110 can also avoid the long-term use problem caused by looseness of the screw while maintaining the stability of mounting of the motor 200, thus improving the durability and structural reliability of the massage gun, and further conforming to the design intention of the present disclosure in compactness, small size, and easy assembling.

First, the motor 200 generates vibrations with a particular amplitude and noises in an operation process. By adding the shock-absorbing pad between the fixed plate 220 and the housing 100, it can effectively absorb and buffer mechanical vibrations caused by high-speed operation of the motor 200 and also reduce transmission and dispersion of the vibrations to the housing 100, thereby achieving the purpose of shock absorption and noise reduction, and improving the comfort and experience of a user during use.

Second, the shock-absorbing pad itself has resilience and compression resistance, so that a pretightening force is formed with the fixed plate 220 in a mounted state, which helps to improve the stability of the fixed plate 220 inside the positioning slot 110, prevent the fixed plate 220 from being loosened or moving during long-term use, and further improve the reliability of mounting and structural stability of the motor 200.

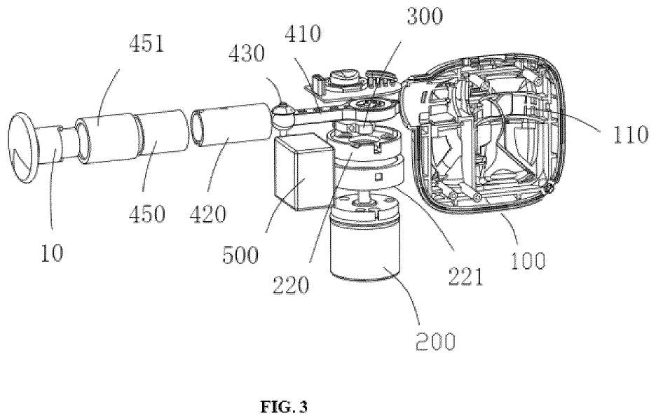

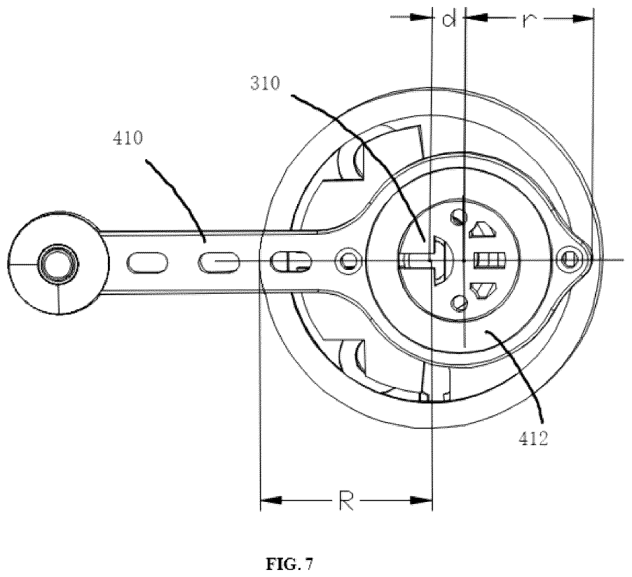

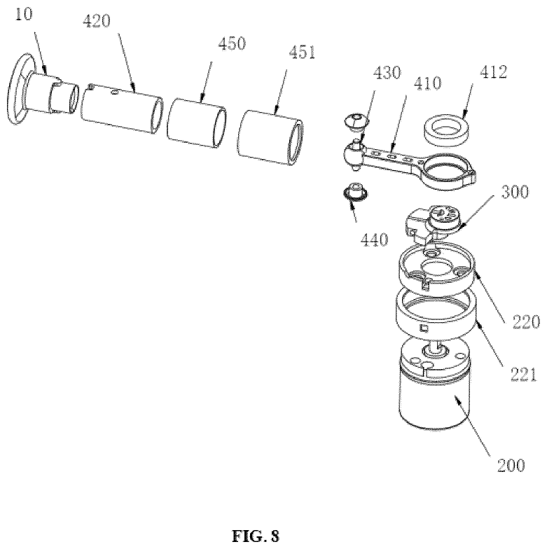

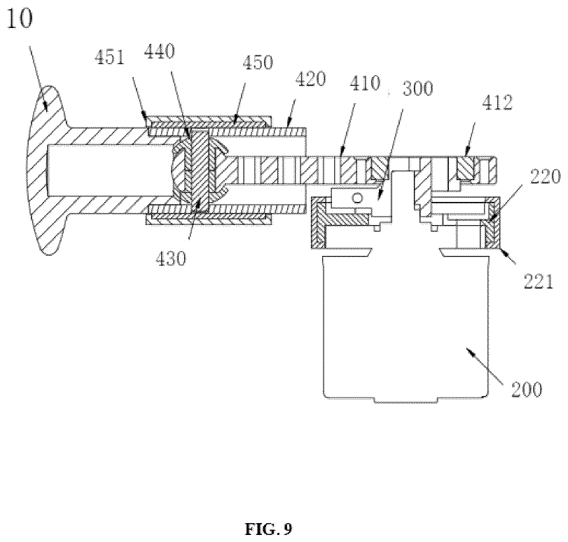

Referring to FIG. 3 to FIG. 9, in this implementation case, the transmission mechanism 400 includes a transmission rod 410 and a sleeve 420. Two ends of the transmission rod 410 are respectively hinged with the sleeve 420 and the eccentric wheel 300. A hinged joint between the transmission rod 410 and the sleeve 420 is located inside the sleeve 420. In the existing massage gun, the hinging between the transmission rod 410 and the sleeve 420 is mainly implemented by cooperative hinging between the bearing 412 and the rotating shaft. However, in the portable massage gun, this hinging manner has two drawbacks. In one aspect, in the hinging manner based on the rotating shaft, the rotating shaft has a large width and is not conducive to controlling the thickness of the portable massage gun. In another aspect, in fixing manner based on the rotating shaft, a hinged point between the transmission rod 410 and the sleeve 420 is located at a rear end of the sleeve 420. This hinged structure makes the sleeve 420 have an extremely large length, which is not conducive to controlling the length of the portable massage gun. By setting the hinged point between the transmission rod 410 and the sleeve 420 inside the sleeve 420, a length of a transmission path is greatly shortened, thus avoiding the problem of a lengthy structure caused by the external arrangement of the traditional rotating shaft. This effectively reduces an overall longitudinal size of the massage gun and meets a compact layout requirement of the portable product.

In this implementation, an outer diameter of the transmission rod 410 is less than an inner diameter of the sleeve 420, which means that the transmission rod 410 does not cause radial interference inside the sleeve 420, thus ensuring that axial sliding motion of the sleeve 420 cannot be hindered while a hinge function is achieved. By this structural cooperation, the sleeve 420 can still smoothly do reciprocating motion inside the sliding shaft sleeve 450 in a process of completing eccentrically driven swinging by the transmission rod 410, which ensures the coordination and smoothness of the overall operation of the transmission mechanism 400.

In this implementation case, a positioning hole 421 is formed in a side wall of the sleeve 420. A through hole 413 is formed in the transmission rod 410. An insertion pin 430 is arranged in the positioning hole 421 and the through hole 413 to implement hinging between the transmission rod 410 and the sleeve 420. Specifically, the positioning hole 421 is formed in the side wall of the sleeve 420 for radial guidance on the insertion pin 430. The through hole 413 is formed in a position, which corresponds to the sleeve 420, on the transmission rod 410. The through hole 413 corresponds to the positioning hole 421 in the sleeve 420. In the assembling process, the rotatable connection between the transmission rod 410 and the sleeve 420 can be implemented by sequentially threading the insertion pin 430 through the positioning hole 421 and the through hole 413.

Compared with the traditional hinging manner based on the rotating shaft or the bearing 412, a diameter of the insertion pin 430 can be designed to be smaller, to achieve high fitting precision. This effectively reduces the space occupation of a hinged structure in a width direction and is very suitable for a structural requirement of the portable miniature massage gun.

In this implementation case, a bushing 440 is arranged between the transmission rod 410 and the sleeve 420. The bushing 440 is in close contact with an inner wall of the sleeve 420.

The bushing 440 extends into the through hole 413 and is located between an inner wall of the through hole 413 and the insertion pin 430, to improve the connection stability and operation smoothness of hinged parts. Specifically, the bushing 440 sleeves the outer side of the transmission rod 410 and is mounted inside the sleeve 420, and the outer wall of the bushing 440 is in close fit with the inner wall of the sleeve 420. The bushing 440 is preferably made of a material with good wear resistance and elasticity. In one aspect, the close contact between the bushing 440 and the inner wall of the sleeve 420 can effectively fill a gap between the transmission rod 410 and the sleeve 420, which improves the positioning precision of connected parts, prevents shaking or vibrations caused by an excessively large gap, and helps to improve the operation stability of an entire transmission system. In another aspect, the bushing 440 serves as a transitional buffer layer, which can absorb a part of an impact force and some of the vibrations during the movement of the transmission rod 410, thereby reducing friction noises between components and prolonging the service lives of key components, especially the sleeve 420 and the insertion pin 430. Meanwhile, the bushing 440 also has a good lubrication function, which can reduce sliding resistance and wear during high-frequency reciprocating motion, to further improve the operation smoothness and silencing performance of the whole machine.

The bushing 440 extends into the through hole 413 and is located between an inner wall of the through hole 413 and the insertion pin 430, In one aspect, the bushing 440 forms an interference or adhesion type buffer layer inside the through hole 413, which can effectively absorb a shaking clearance caused by an assembling tolerance between the insertion pin 430 and the through hole 413, and improve the positioning precision and structural stability of the insertion pin 430. In another aspect, the material of the bushing 440 itself has good flexibility and wear resistance. When located around the insertion pin 430, the bushing 440 can play a role in buffering, wear prevention, and noise reduction, to avoid noises or damage caused by direct friction between the insertion pin 430 and a metal part during high-frequency motion. Meanwhile, this design can also reduce axial and radial wear of the insertion pin 430 during motion to an extent, prolong the service life of the insertion pin 430, and improve the reliability and service life of the transmission system of the entire machine.

In this implementation case, a sliding shaft sleeve 450 is arranged inside the housing 100. The sleeve 420 is located inside the sliding shaft sleeve 450. A silicone sleeve 451is arranged between the sliding shaft sleeve 450 and the housing 100. To further optimize the stability and comfort of the transmission mechanism 400 during operation, a silicone sleeve 451 is arranged between the sliding shaft sleeve 450 and the housing 100. That is, a round of flexible buffer material is wrapped around an outer side of the sliding shaft sleeve 450 to form flexible fit with an inner wall of the housing 100. When the transmission mechanism 400 does high-speed reciprocating motion, small vibrations and an impact force that are generated during mechanical motion can be effectively absorbed, thereby reducing noises and a vibration sensation during the operation of the whole machine and enhancing the user experience.

Referring to FIG. 1 to FIG. 2, in this implementation case, the portable miniature massage gun further includes a control panel 600. The control panel 600 is located above the transmission mechanism 400, and the control panel 600 is provided with an operation button 610 and a power indicator lamp 620. To improve the operation convenience, the control panel 600 is provided with the control button 610 and the power indicator lamp 620. The control button 610 is configured to turn on/off equipment, start/stop the motor 200, switch gears, and perform other operation functions. The power indicator lamp 620 is configured to display a current battery power state in real time, making it convenient for a user to know the remaining power during use and charge the equipment in a timely manner.

Specifically, due to the ergonomic optimization design on the position of the control panel 600, when a user normally holds the massage gun, the thumb can naturally fall within a region of the control panel 600, to facilitate one-hand control operations. This layout avoids the inconvenience of use of the traditional massage gun that requires a “backhand button” or “blind press”, and improves the operation intuitiveness and use comfort of the product.

After the motor is started, the output shaft of the motor drives the eccentric wheel to rotate, and the eccentric circular boss of the eccentric wheel produces eccentric motion. The bearing located on the outer side of the eccentric circular boss transmits power to the transmission rod, and one end of the transmission rod does circumferential motion around the eccentric circular boss. Since another end is hinged with the sleeve and is limited by the sliding shaft sleeve, this circumferential motion is converted into reciprocating linear motion of the sleeve in the axial direction of the massage gun, thereby driving the massage head at a front end to perform periodic impact and achieve a relaxation and massage effect on muscles.

In this process, a plurality of structural optimizations work together:

The stacking and embedding design of the eccentric circular boss and an axial projection of the output shaft reduces a height of a driving mechanism.

The trajectory restriction design with r+d<R ensures that the transmission rod always moves within the contour of the fixed plate, thus avoiding structural exposure.

A plurality of hinged structures (such as an insertion pin, a boss, and a positioning ball) are combined with the bushing, which can improve the assembling precision and the transmission steadiness.

A combined structure of the sliding shaft sleeve and the silicone sleeve implements shock absorption and noise reduction during operation.

The power source is placed horizontally inside the corner formed by the motor and the transmission mechanism, so that the utilization rate of the internal space is maximized, and the length of the entire machine is reduced.

The control panel is arranged in a region easily operated by a user, so that it is convenient for the user to adjust gears, turn on or turn off the power source, and check the battery life through the operation button.

Through the above structural cooperation and the process path design, the present disclosure implements a rotation-decentration-reciprocating efficient power conversion process, and achieves high integration, size reduction, and function optimization of the overall device while ensuring implementation of a massage function. It is particularly suitable for personal health massage equipment scenarios with strict requirements for portability and miniaturization.

In summary, the present disclosure provides an overall solution of a miniature massage gun suitable for a portable application scenario by optimizing internal structures of the massage gun in a plurality of aspects. Specifically, it includes:

By setting the motor 200 and the transmission mechanism 400 in the corner layout and embedding the power source 500 at the corner, the utilization rate of the internal space of the housing 100 is effectively increased, and overall structural flattening and miniaturization of the massage gun are implemented.

By optimizing the spatial relationship between the eccentric wheel 300 and the output shaft 210 of the motor 200, the axial projection of the output shaft 210 falls within the contour range of the eccentric wheel 300, which reduces the longitudinal space occupation to the greatest extent

By forming the circular slot 411 on the outer side of the eccentric circular boss 310, combining the bearing 412, and ensuring that the parameter design satisfies the constraint relationship of r+d<R, the motion trajectory of the transmission rod 410 does not exceed the outer diameter of the fixed plate 220, which further reduces the size of the entire machine and optimizes the spatial layout.

By using the various lightweight and compact hinged structures between the transmission rod 410 and the sleeve 420 such as the insertion pin 430, a boss, or a positioning ball, a length and width of the transmission mechanism 400 are effectively reduced, and the overall compactness of the massage gun is improved.

By arranging flexible buffer structures such as the sliding shaft sleeve 450 and the silicone sleeve 451, vibrations and noises are reduced, and the comfort and durability of the miniature massage gun in a high-frequency operation environment are improved.

The ergonomically optimized layout of the control panel 600 balances the portability and the one-hand operation convenience, and enhances the user experience.

Through the above multi-dimensional structural innovations, the present disclosure has successfully implemented high integration and extreme miniaturization of the massage gun product through, significantly improves the portability, the maneuverability, and the usage comfort, and has a good application prospect and market competitiveness.

It should be finally noted that: The foregoing embodiments are merely preferred embodiments of the present disclosure, but not intended to limit the present disclosure. Although the present disclosure is described in detail with reference to the foregoing embodiments, a person of ordinary skill in the art may still make modifications to the technical solutions described in the foregoing respective embodiments or make equivalent replacements to partial technical features thereof. Any modification, equivalent replacement, and improvement made within the spirit and scope of the present disclosure shall fall within the protection scope of the present disclosure.

What is claimed is:

1. A portable miniature massage gun, comprising:
a housing (100), wherein a hollow cavity is provided in the housing (100);
a motor (200), mounted inside the housing (100), wherein a rotating shaft of the motor (200) is connected with an eccentric wheel (300);
a transmission mechanism (400), slidably mounted inside the housing (100), wherein the transmission mechanism (400) comprises a transmission rod (410) and a sleeve (420); two ends of the transmission rod (410) are respectively hinged with the sleeve (420) and the eccentric wheel (300); and
a power source (500), configured to supply electrical energy,
wherein a corner is formed between the motor (200) and the transmission mechanism (400); and the power source (500) is mounted at the corner inside the housing (100) to make the housing (100) flat.

2. The miniature massage gun according to claim 1, wherein an eccentric circular boss (310) is arranged on the eccentric wheel (300); a central axis of the eccentric circular boss (310) is staggered from an output shaft (210) of the motor (200); and
in an axial projection direction, the output shaft (210) of the motor (200) is located within a contour of an outer edge of the eccentric circular boss (310), to cause the output shaft (210) of the motor (200) to extend into the eccentric circular boss (310).

3. The miniature massage gun according to claim 2, wherein a circular slot (411) is formed in one end of the transmission rod (410); the end of the transmission rod (410) sleeves an outer side of the eccentric circular boss (310) through the circular slot (411); and a bearing (412) is arranged between the eccentric circular boss (310) and the transmission rod (410).

4. The miniature massage gun according to claim 3, wherein the motor (200) is an outer rotor motor; the motor (200) is mounted inside the housing (100) through a fixed plate (220);
a maximum radius of an outer wall of the circular slot (411) is r; an eccentric distance of the eccentric circular boss (310) is d; a radius of the fixed plate (220) is R; and
a sum of the maximum radius r of the outer wall of the circular slot (411) and the eccentric distance d of the eccentric circular boss (310) is less than the radius R of the fixed plate (220), to cause an outer diameter of a circumferential displacement trajectory of the transmission rod (410) to be less than an outer diameter of the fixed plate (220).

5. The miniature massage gun according to claim 4, wherein a first shock-absorbing pad (221) is arranged on an outer side wall of the fixed plate (220); and the first shock-absorbing pad (221) is located between the fixed plate (220) and the housing (100).

6. The miniature massage gun according to claim 1, wherein a hinged joint between the transmission rod (410) and the sleeve (420) is located inside the sleeve (420).

7. The miniature massage gun according to claim 6, wherein a positioning hole (421) is formed in a side wall of the sleeve (420); a through hole (413) is formed in the transmission rod (410); and an insertion pin (430) is arranged in the positioning hole (421) and the through hole (413) to implement hinging between the transmission rod (410) and the sleeve (420).

8. The miniature massage gun according to claim 7, wherein a bushing (440) is arranged between the transmission rod (410) and the sleeve (420); the bushing (440) is in close contact with an inner wall of the sleeve (420); and
the bushing (440) extends into the through hole (413) and is located between an inner wall of the through hole (413) and the insertion pin (430).

9. The miniature massage gun according to claim 6, wherein a sliding shaft sleeve (450) is arranged inside the housing (100); the sleeve (420) is located inside the sliding shaft sleeve (450); and a silicone sleeve (451) is arranged between the sliding shaft sleeve (450) and the housing (100).

10. The miniature massage gun according to claim 1, further comprising a control panel (600), wherein the control panel (600) is located above the transmission mechanism (400), and the control panel (600) is provided with an operation button (610) and a power indicator lamp (620).
